(19) United States
(12) Patent Application Publication
(10) Pub. No.: US 2014/0256258 A1
(43) Pub. Date: Sep. 11, 2014

(54) PARKED VEHICLE LOCATING SMARTPHONE APPLICATION

(71) Applicant: Joan DeLuca, Boca Raton, FL (US)

(72) Inventor: Joan DeLuca, Boca Raton, FL (US)

(21) Appl. No.: 13/787,632

(22) Filed: Mar. 6, 2013

(51) Int. Cl. H04W 4/00

(52) U.S. Cl. CPC H04W 4/008
USPC 455/41.2

(57) ABSTRACT

A smartphone automatically determines the location of a parked vehicle by monitoring a received signal associated with the vehicle and a motion of the smartphone. If the smartphone travels a distance greater than the coverage area of received signal while in range of the received signal, then the smartphone is determined to be traveling in a vehicle. A typical Bluetooth signal range is ten meters while a typical vehicle trip is significantly greater. The location of the smartphone is correlated to the location of the parked vehicle when the absence of the received signal is determined. Pairing of a smartphone with a Bluetooth equipped vehicle is not required to automatically determine the parked vehicle location.

The present disclosure relates to the field of vehicle location, and particularly locating a parked vehicle using a smartphone.

### BACKGROUND

Vehicle parking lots have grown in size due in part to the development of large department stores and shopping malls. Often times a driver of a vehicle parks in the large parking lot for shopping or other business. When the driver or passenger returns to the parking lot they may not be able to remember the location of the automobile and thus can waste a significant amount of time hunting for the automobile in the large parking lot. Modern vehicle also are often equipped with Bluetooth interfaces to facilitate pairing with smartphones carried by vehicle occupants for use with the vehicle telematics system to make handsfree phone calls, enhance in-vehicle entertainment or other telematics purposes. Drivers and other frequent occupants have smartphones that automatically pair with the vehicle, while other occupants may have smartphones that not be configured to pair with the vehicle either because of the tedious nature of Bluetooth pairing or they may not be authorized to pair or they may prefer not to pair their smartphone with the vehicle.

Due to advances in technology, portable devices such as smartphones are carried by a large portion of the population. Smartphones can pair with vehicles using Bluetooth and also have complete navigation systems including GPS for determining location and velocity, a compass for determining heading, navigation system for providing route guidance to identified locations. Smartphones are also capable of operating application modules that enhance the functionality of smartphones and help solve problems users encounter on a frequent basis in ways that are new and useful.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 shows a representative block diagram of a smartphone receiving a radio signal from vehicle electronics system.

FIG. 2 shows a representative flow diagram of a car finder application module operating in accordance with the present disclosure.

FIG. 3 shows a representative flow diagram of a process for returning to a parked vehicle.

### DETAILED DESCRIPTION

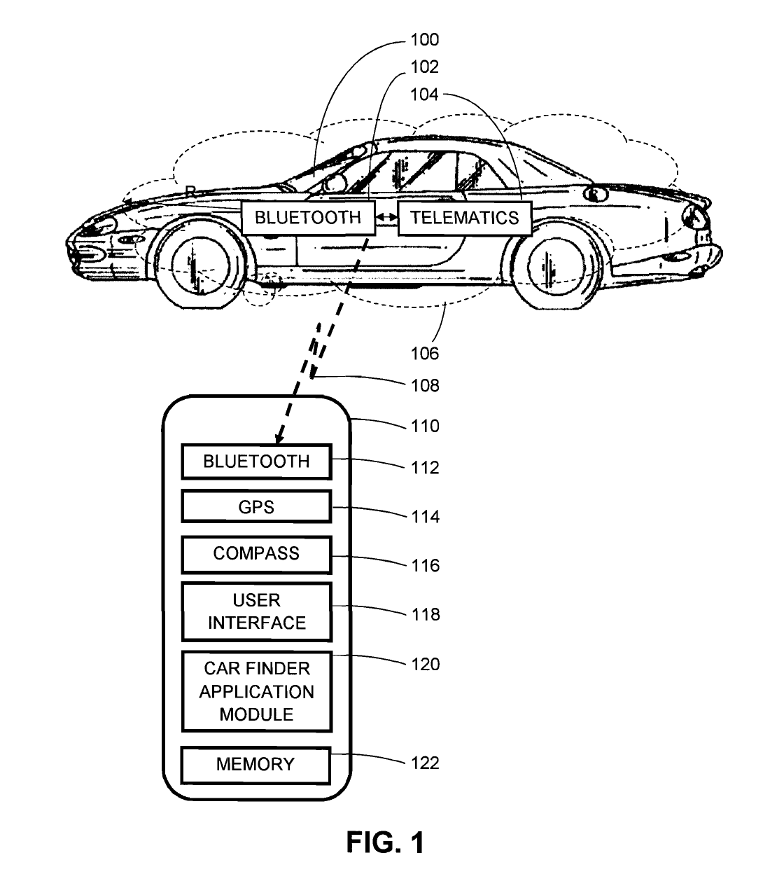

FIG. 1 shows a representative block diagram of a smartphone receiving a radio signal from vehicle electronics system. Vehicle 100 includes an automobile electronics system that has a Bluetooth transceiver 102, having a transmitter for transmitting a Bluetooth radio and a receiver for receiving a Bluetooth radio signal. Vehicle 100 also has an optional vehicle telematics system 104 which interfaces with the Bluetooth transceiver for facilitating access to components of the vehicle electronic system and enable a number of functions. Such functions include handsfree telephone calls, vehicle entertainment content provision and control and access to navigation related information generated by a vehicle navigation system. The Bluetooth transceiver may be original equipment installed in a vehicle at the time of manufacturer or an aftermarket product, such as an aftermarket Bluetooth handsfree phone kit. The Bluetooth transceiver allows for pairing of devices such as smartphone or other portable devices enabled with Bluetooth functionality. Bluetooth transceivers have a coverage area 106 having a specified radius R that establishes a Bluetooth site. The radius R, according to the Bluetooth standard definition, can be varied with increased or decreased power outage. The specified coverage radius may also vary on the implementation of the Bluetooth antenna system and the vehicle cabin characteristics. A common Class 2 Bluetooth site with optimal conditions will produce coverage radius of ten meters. Other currently specified classes of Bluetooth can produce coverage ranges between one and one hundred meters. Vehicle 100 may be any type of vehicle capable of generating a radio signal that a user possessing a smartphone or similar device would use to travel while in possession of the smartphone. Examples of vehicle 100 include aircraft, watercraft, cars, trucks, motorcycles, tractors, bicycles, mopeds, and motorized chairs.

Smartphone 110 includes a Bluetooth module 112 including a Bluetooth radio receiver for receiving a Bluetooth signal 108 from vehicle 100 while located within the coverage area 106, and potentially for pairing with the vehicle electronics system. Consequently, the Bluetooth receiver is able to detect the presence or absence of the Bluetooth radio signal. The smartphone also includes (Global Positioning System) GPS 114 for determining location and velocity of the smartphone and an optional compass 116 for determining a heading of the smartphone. When operating a navigation application, the GPS and optionally the compass, can be used to determine a route to an identified location and provide indications of the route to a user of the smartphone via user interface 118. User interface may include a graphic display screen with a touch sensitive surface. Alternate user interfaces include tactile buttons and display screens and or indicator lights. Thus, the user interface is capable of communicating a route from a current location of the portable device to the first location corresponding to a parked car. The smartphone also includes a car finder application module 120 for helping occupants of the vehicle to locate the vehicle after it has been parked. Smartphones able to route from one location to another location are well know to those familiar with the art. The car finder application module may operate software processes stored in memory 122. The car finder application module 120 acts as a location recorder for recording a location of the portable device in response to the absence of the radio signal and the motion of the portable device complying with a characteristic. The car finder application module may be stored on a computer readable storage medium having computer readable program code embodied therewith, and installed on the smartphone as original equipment or as an aftermarket installation via wireless or wired downloading from an application distribution function, a personal computer, or a memory module coupled to the smartphone.

Smartphone 110 may be any portable device such as a PDA, PIM, cell phone, feature, smartphone, super phone, electronic book, tablet, laptop, ultra-book or other such portable device possessed by a user while traveling in a vehicle. Such portable devices have operating systems provided by entities such as Microsoft, Apple, Google, Nokia, BlackBerry, Palm, General Magic or others.

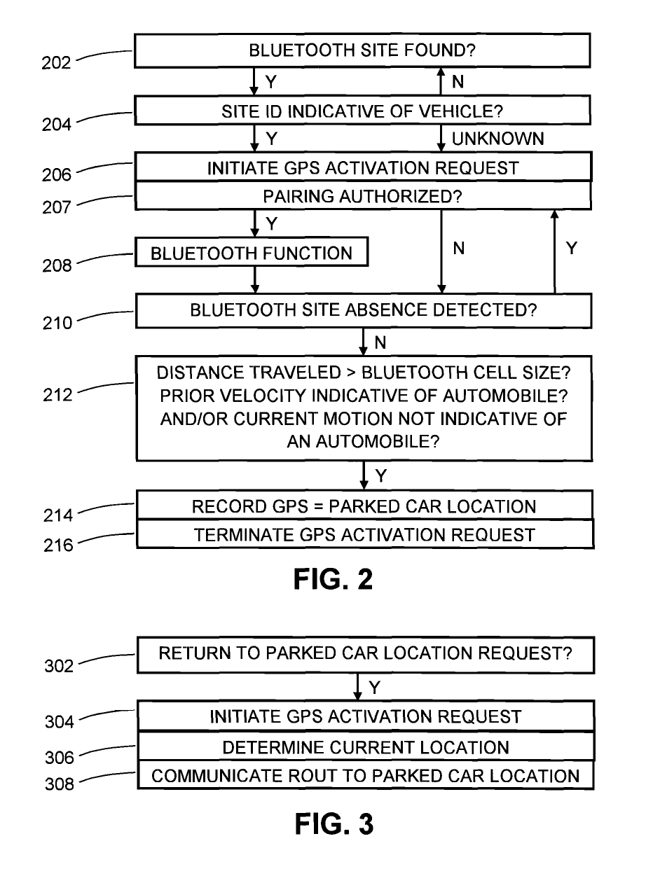

FIG. 2 shows a representative flow diagram of a car finder application module operating in accordance with the present disclosure. Step 202 determines if a Bluetooth site has been found. If so, step 204 checks if the site has a name or identification signal associated with the Bluetooth site. The Bluetooth site may include an identification signal that the car finder application module recognizes as a vehicle, this would indicate that the user of the smartphone is within the vicinity of the vehicle. The Bluetooth site may be recognized as a vehicle because its identification signal may correspond to a vehicle the smartphone has previously paired with, or may correspond to a list of identification signals correspond to vehicles, even if the smartphone has not paired with the particular vehicle. The list of identification signals may be resident in memory 122 or may accessible to the smartphone via the cloud. Optionally, if at step 204 the Bluetooth site is positively identified as not being associated with a vehicle, then step 202 returns to the continue attempting to find new Bluetooth sites. Examples of Bluetooth sites that are not associated vehicles include smartphones and home entertainment systems. If the site is unknown, that is it cannot be determined whether or not the radio signal is generated by a vehicle or a device associated with a vehicle, then the flow diagram proceeds to step 206. While in this example a Bluetooth radio signal is described, it should be appreciated that in other examples, other vehicle transmitted radio signals can be used, such as vehicle wireless security systems providing secure access to the vehicle, wireless headphone signals, low power FM transmitters, telematics communication systems such as On-Star or vehicle WiFi transmissions, or other radio signals such as electromagnetic energy or interference generated by the vehicle electronics system.

Step 206 then initiates a GPS activation request. In response to the request, the smartphone activates the GPS receiver, if it is not already activated by another smartphone application, in order to determine a motion of the portable device in response to the received radio signal. The GPS receiver may be operated continuously or intermittently to conserve power. Determining the motion of the portable device includes determining the location, velocity and/or distance traveled. While this example uses GPS for determining location, velocity and/or distance, other examples may user other systems capable of providing such information such as Qualcomm's OmniTRACs, the European Union's Global Navigation Satellite System, Russia's GLONASS or China's Compass positioning systems.

Step 207 determines if Bluetooth pairing is authorized between the smartphone and the Bluetooth site. Bluetooth pairing is typically pre-authorized during a prior coupling to the Bluetooth site and the coupling remembered for automatic pairing on subsequent couplings. If pairing is authorized, then the Bluetooth pairing occurs and corresponding Bluetooth functionality is enabled. The pairing can allow access to the vehicle telematics system and use of the corresponding features such as handsfree calling and access or content provision of the vehicle entertainment system. The pairing can also allow the smartphone to access the vehicle navigation information, including location and velocity, from the telematics system, in which as the car finder module could either terminate or avoid initiating its request for use of the smartphone GPS module resource and conserve smartphone battery power. Whether or not Bluetooth pairing occurs, the motion of the portable device is monitored. The smartphone can detect that it is in the presence of a Bluetooth site. Pairing with the Bluetooth site is not required to detect the presence of the Bluetooth signal.

Step 210 determines the absence of the Bluetooth signal. In a vehicle, the absence of the Bluetooth signal corresponds to the vehicle be powered off and thereby parked, or the user possessing the smartphone leaving the vicinity of the vehicle. Then step 212 determines if the motion of the portable device complies with a characteristic. The characteristic may be indicative of a user possessing the smartphone having just traveled in a vehicle which became parked. One characteristic is determining if the distance traveled is greater than the Bluetooth coverage area while the smartphone remained in Bluetooth site coverage area. If the Bluetooth site was associated with a vehicle, then the vehicle may travel several miles prior to parking. Since the radius of Bluetooth site is significantly less than several miles, typically ten meters, and the smartphone traveled more than ten meters, the Bluetooth site is included in the vehicle in which the user was traveling. Another example criterion is to check the GPS velocity while remaining in range of the Bluetooth coverage area. If the GPS velocity exceeds a threshold velocity, say twenty five miles an hour for example, while remaining in range of the Bluetooth coverage area, the Bluetooth signal can be associated with a vehicle. Another criterion can include determining if the motion of the smartphone after the absence of the Bluetooth radio signal is detected is indicative of the user having left a parked vehicle. Such a motion may include a slow walking speed velocity, such as a three mile an hour or less velocity. In this example, walking can be determined by a velocity not exceeding a second value such as five miles per hour. Additionally or alternately, a smartphone accelerometer can be monitored to determine if the user is walking by determining an acceleration motion indicative of a user walking or running. Thus, a motion detector for detecting the motion of the smartphone can include a GPS receiver resident in the smartphone, a GPS receiver resident in the vehicle, an accelerometer resident in the smartphone and a compass for determining a heading.

Additionally, the motion analysis may be supplemented or replaced with the determination that the Bluetooth site is associated with the vehicle. If the Bluetooth signal includes an identification signal indicative of a vehicle, then the location can be without regard for the motion of the portable device.

If one or more of the motions of the portable device complies with the criterion, then it is determined that the smartphone in possession of the user is leaving a parked car and the GPS location is recorded to be the approximate location of the parked car at step 214. Additional analysis of the environment around the time of the termination of the Bluetooth signal can be used to more accurately pinpoint an estimated location of the vehicle. For example, if the Bluetooth signal remained on as the user walked away from the vehicle, then the location where the Bluetooth signal was lost could be off by as much as ten meters or more from the location of the vehicle, for a class two Bluetooth site. By analyzing the Bluetooth signal power before termination as well as the time variant location of the smartphone, the parked car location would more accurately determined. One approach to more accurately determine the parked car location includes setting the recorded location to correspond to the last location with a non-decreasing Bluetooth power signature, which is indicative of the user being in the car while in possession of the smartphone. Another approach includes determining the last location where the velocity was zero, corresponding to the location where the user began walking away from a stopped and parked car. Many other approaches are feasible. Then, step 216 terminates the request to activate the GPS to conserve power.

FIG. 3 shows a representative flow diagram of a process for returning to a parked vehicle. If in step 302 a request is received to return to the parked car location, which was automatically determined at step 214, then a GPS activation request is initiated at step 304, the current location is determined at step 306, and a route communicated at step 308. In one example, a user activates the car finder application on the smartphone. The parked car location was determined in the background, without requiring user activity, and the routing location determines a route from the current location to the parked car location. The route could be a display of a map with a desired path, or could be left or right lights indicating a desired heading towards the vehicle. Also the distance or closeness can to the vehicle can be communicated by varying a rate of a flashing light, or generating an indicative tone.

One advantage of the description herein is the advantage of automatically determining the location of a vehicle without requiring an established interface with the vehicle. Thus, in one example, a first time passenger in a Bluetooth enable rental car can find their way back to the parked rental car without being required to learn and execute the tedious steps to pair their smartphone to the rental car, or to remember to take the time to enter a manual input on the smartphone to log a parked car location at the time of leaving the rental car. The location of the parked vehicle is automatically identified, transparently in the background, without requiring the user to take any actions to pair with a vehicle's Bluetooth system or to record the parked car location.

FIG. 2 and FIG. 3 depict flowcharts illustrating methods performed by various devices of the described examples. These methods may be carried out by software executed, for example, by the main processor of the smartphone. Coding of software for carrying out such methods is within the scope of a person of ordinary skill in the art given the present description. These methods may contain additional or fewer processes than shown and/or described, and may be performed in a different order. Further, the components of one or more of these methods are able to be performed by one processor or divided among multiple processors. Additionally, while these exemplary methods are illustrated with a particular order of steps, those of ordinary skill in the art will appreciate that the steps illustrated for these methods can be executed in any order that accomplishes the technical advantages of the present disclosure and can include fewer or more steps than illustrated. Additionally, components of the several methods described herein are able to be combined into various composite methods that are performed by one processor or distributed among two or more processors. Computer-readable code executable by at least one processor of the portable electronic device to perform the method may be stored in a computer-readable medium, which may be a non-transitory or tangible storage medium.

The logical operations of various examples are implemented as: a sequence of computer-implemented steps, operations, or procedures running on a programmable circuit within a general use computer, a sequence of computer-implemented steps, operations, or procedures running on a specific-use programmable circuit; and/or interconnected machine modules or program engines within the programmable circuits. The portable electronic device can practice all or part of the recited methods, can be a part of the recited systems, and/or can operate according to instructions in the recited non-transitory computer-readable storage medium. Such logical operations can be implemented as modules configured to control a processor to perform particular functions according to the programming of the module.

Examples also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including smart-phones, personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that communicate (either over hardwired channels, wireless channels, or by a combination thereof) through a communications network. In a distributed computing environment, program modules may be located in both local and remote memory storage devices.

Presently preferred implementations of the disclosure and many of improvements and advantages thereof have been described with a degree of particularity. The description is of preferred examples of implementing the disclosure, and the description of examples is not necessarily intended to limit the scope of the disclosure. The scope of the disclosure is defined by the following claims.

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). According to context, the term “coupled,” as used herein, is generally defined as “connected,” although not necessarily directly, and not necessarily mechanically Components that are “communicatively coupled” are configured to communicate (that is, they are capable of communicating) in any fashion for any duration, such as by way of electric signals, optical signals, wireless signals, or any combination thereof. Communicatively coupled components are able to be directly connected to one another, connected through any combination of intermediate physical components or other elements that support communications between the communicatively coupled components, connected at least in part by one or more electromagnetic, optical or similar communications medium, by one or more other coupling components, or by combinations of these. The terms “configured to” and “adapted to” describe hardware, software or a combination of hardware and software that is (according to context) capable of, set up, arranged, built, composed, constructed, designed, able to accommodate or make, suitable to carry out or that has any combination of these characteristics to carry out a given function. In the following discussion, “handheld” is used to describe items, such as “handheld devices,” that are sized, designed and otherwise configured to be carried and operated while being held in a human hand.

The present disclosure may be embodied in other specific forms without departing from its essential characteristics. The described examples are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. In a portable device, a method comprising:
determining a presence of a radio signal;
detecting a motion of the portable device in response to the presence of the radio signal;
determining an absence of the radio signal; and
identifying a first location of the portable device in response the absence of the radio signal and the motion of the portable device complying with a characteristic.

2. The method according to claim 1 wherein the radio signal is generated by a vehicle electronic system facilitating a secure access to the vehicle.

3. The method according to claim 1 wherein the radio signal is a Bluetooth signal.

4. The method according to claim 3 wherein the portable device is a smartphone that does not pair with the Bluetooth signal.

5. The method according to claim 3 wherein the portable device is a smartphone that uses the Bluetooth signal to pair with a vehicle electronic system in order to access components of the vehicle electronic system.

6. The method according to claim 1 wherein the radio signal is a Bluetooth signal having an identification signal indicative of an electronic device generating the Bluetooth signal wherein the identifying is not performed in response a determination that the identification signal is not associated with a vehicle.

7. The method according to claim 1 wherein the radio signal includes an identification signal indicative of an electronic device generating the radio signal wherein the identifying the first location of the portable device occurs in response to the absence of the radio signal and the identification signal being associated with a vehicle and without regard for the motion of the portable device.

8. The method according to claim 1 wherein the characteristic corresponds to a velocity exceeding a threshold.

9. The method according to claim 1 wherein the characteristic corresponds to the portable device traveling a distance while the radio signal is received.

10. The method according to claim 9 wherein the radio signal is a Bluetooth signal generated by an automobile electronic system and the distance is greater than a radius of a coverage area of the Bluetooth signal.

11. The method according to claim 1 wherein the characteristic corresponds to a velocity of the portable device exceeding a first value while the radio signal is received and the velocity of the portable device not exceeding a second value upon determining the absence of the radio signal.

12. The method according to claim 1 further comprising determining a route to from a current location of the portable device to the first location in response to a manual input.

13. A portable device comprising:
a receiver for detecting a presence and an absence of a radio signal;
a motion detector for detecting a motion of the portable device in response to the presence of the radio signal; and
a location recorder for recording a first location of the portable device in response to the absence of the radio signal and the motion of the portable device complying with a characteristic.

14. The portable device according to claim 13 wherein the radio signal has a coverage area and the characteristic of the motion corresponds to the portable device moving a distance greater than the coverage area in the presence of the radio signal.

15. The portable device according to claim 13 wherein the portable device is comprised within a system further including a vehicle having a transmitter for transmitting the radio signal.

16. The portable device according to claim 13 further comprising a user interface for communicating a route from a current location of the portable device to the first location.

17. A computer readable storage medium having computer readable program code embodied therewith, the computer readable program code comprising instructions for:
determining a presence of a radio signal;
detecting a motion of a portable device in response to the presence of the radio signal;
determining an absence of the radio signal; and
identifying a first location of the portable device in response the absence of the radio signal and the motion of the portable device complying with a characteristic.

18. The computer readable storage medium according to claim 17 wherein the radio signal has a coverage area and further comprising instructions for determining if the motion of the portable device complies with the characteristic if the motion of the portable device corresponds to the portable device traveling a distance greater than the coverage area while the radio signal is not determined to be absent.

19. The computer readable storage medium according to claim 17 further comprising instructions for determining if the motion of the portable device complies with the characteristic if the motion of the portable device corresponds to the portable device traveling a velocity greater than a threshold velocity while the radio signal is not determined to be absent.

20. The computer readable storage medium according to claim 17 further comprising instructions for determining a route from a current location of the portable device to the first location.
